(19) United States
(12) Patent Application Publication
(10) Pub. No.: US 2023/0257135 A1
(43) Pub. Date: Aug. 17, 2023

(54) MICRO-CATHODE ARC PROPULSION SYSTEM

(71) Applicant: HARBIN INSTITUTE OF TECHNOLOGY, Harbin (CN)

(72) Inventors: Liqiu Wei, Harbin (CN); Yongjie Ding, HARBIN (CN); Hong Li, HARBIN (CN); Liang Han, HARBIN (CN); Daren Yu, HARBIN (CN)

(21) Appl. No.: 17/918,901

(22) PCT Filed: Sep. 14, 2020
(86) PCT No.: PCT/CN2020/115008

§ 371 Date: Oct. 14, 2022

(30) Foreign Application Priority Data
Apr. 16, 2020 (CN) 202010298568.1

(51) Int. Cl. B64G 1/40; H05H 1/46; B64G 1/42

(52) U.S. Cl. CPC B64G 1/406; H05H 1/4652; B64G 1/428

(57) ABSTRACT

A micro-cathode arc propulsion system. By replacing an inductive circuit in a traditional micro-cathode arc propulsion system with a capacitor circuit, the stability of the operation of a micro-cathode arc thruster can be improved due to the stable discharging mode of the capacitor, and as the internal resistance of the capacitor is small during operation, the additional power consumption of the circuit is reduced, and the efficiency of the system is improved. In addition, as a pulse power supply is used to power in a pulse manner, the average power inputted into the micro-cathode arc thruster is greatly reduced.

### CROSS-REFERENCE TO RELATED APPLICATION

This application claims priority to Chinese Patent Application No. 202010298568.1 filed on Apr. 16, 2020 and entitled “Micro-cathode arc propulsion system”, the entire contents of which are incorporated herein by reference.

### TECHNICAL FIELD

The present disclosure relates to the technical field of micro propulsion for satellites, and in particular relates to a micro-cathode arc propulsion system.

### BACKGROUND

The micro-cathode arc thruster has become an ideal electric propulsion type for micro-nano satellites due to its advantages of micropowering, high efficiency, high specific impulse, adjustable wide range and low cost, and can be used in missions such as orbit keeping and formation flight of micro-nano satellites. The traditional micro-cathode arc propulsion system circuit is as shown in FIG. 1. The function of a power processing unit (PPU) is to provide hundreds of volts of pulse voltage to the thruster, and the PPU includes an inductor, a pulse generator, an IGBT and a resistor, and its operating principle is that an inductive energy storage mode is adopted, a 20 V direct current (DC) power supply is configured to power the PPU, the charging and discharging of the inductor are controlled by an insulated gate bipolar transistor (IGBT). When a switch is on, the inductor is charged; and when the switch is off, the inductor produces a back voltage to form hundreds of volts of transient high voltage on the thruster. During production of the back voltage, as the inductor has the characteristic of unstable discharging, the instability of inverse voltage may directly cause the instability of the operation of the thruster. In addition, as the back-voltage characteristic of the inductor and the layout of the circuit may cause large power consumption of the PPU circuit, the power inputted into the thruster is increased, and the overall efficiency is reduced.

### SUMMARY

An objective of the present disclosure is to provide a micro-cathode arc propulsion system capable of improving the stability of the operation of a thruster as well as reducing additional power consumption of a circuit.

To achieve the objective above, the present disclosure provides the following technical solutions:

A micro-cathode arc propulsion system comprises:

a power supply, a resistor, a capacitor, an IGBT module and a micro-cathode arc thruster.

A positive electrode of the power supply is connected to one terminal of the resistor, the other terminal of the resistor is connected to one terminal of the IGBT module and one terminal of the capacitor, respectively, and the other terminal of the IGBT module is connected to an anode of the micro-cathode arc thruster. A cathode of the micro-cathode arc thruster and the other terminal of the capacitor are connected to a negative electrode of the power supply.

Alternatively, the IGBT module specifically comprises:

a pulse generator and an IGBT.

The pulse generator is connected to a gate of the IGBT, a drain of the IGBT is connected to the other terminal of the resistor, and a source of the IGBT is connected to the anode of the micro-cathode arc thruster.

Alternatively, the power supply is a 500 V DC power supply.

Alternatively, the resistor has a resistance of 50 kΩ.

Alternatively, the capacitor has a capacitance of 0.5 μf.

Alternatively, the power supply is a pulse power supply.

Alternatively, an insulating layer of the micro-cathode arc thruster is arranged between the cathode and the anode of the micro-cathode arc thruster.

Alternatively, the micro-cathode arc propulsion system further comprises:

a permanent magnet.

The permanent magnet is arranged on the cathode of the micro-cathode arc thruster.

Alternatively, the cathode of the micro-cathode arc thruster, the other terminal of the capacitor and the negative electrode of the power supply are all grounded.

According to specific embodiments of the present disclosure, the present disclosure has the following technical effects:

A micro-cathode arc propulsion system is provided. By replacing an inductive circuit in a traditional micro-cathode arc propulsion system with a capacitor circuit, the stability of the operation of a micro-cathode arc thruster can be improved due to the stable discharging mode of the capacitor, and as the internal resistance of the capacitor is small during operation, the additional power consumption of the circuit is reduced, and the efficiency of the system is improved.

In addition, as a pulse power supply is used to power in a pulse manner, the average power inputted into the micro-cathode arc thruster is greatly reduced.

### BRIEF DESCRIPTION OF THE DRAWINGS

To describe the technical solutions in the embodiments of the present disclosure or in the prior art more clearly, the following briefly introduces the accompanying drawings required for describing the embodiments. Apparently, the accompanying drawings in the following description show merely some embodiments of the present disclosure, and a person of ordinary skill in the art may still derive other drawings from these accompanying drawings without creative efforts.

FIG. 1 is a circuit diagram of a micro-cathode arc propulsion system in the prior art.

FIG. 2 is a circuit diagram of a micro-cathode arc propulsion system in accordance with an embodiment of the present disclosure.

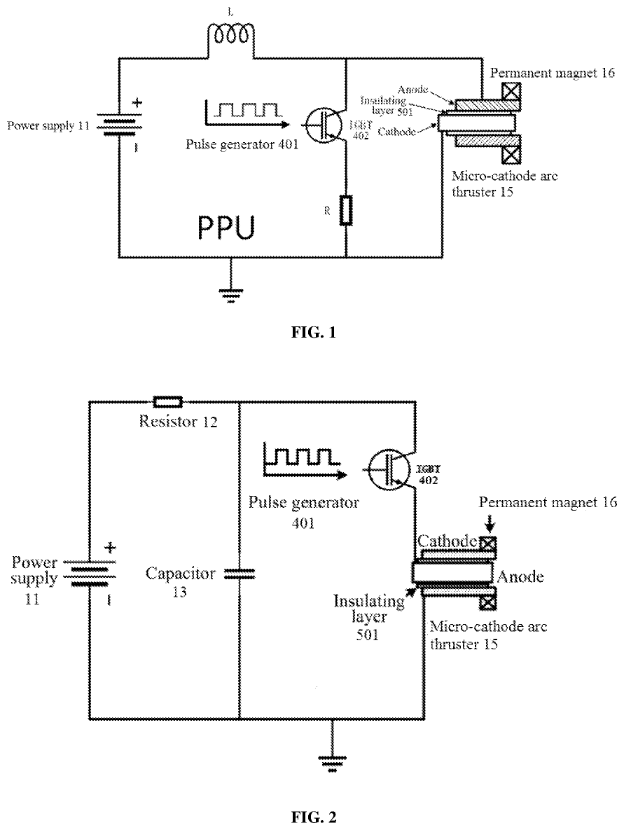

### DETAILED DESCRIPTION OF THE EMBODIMENTS

The following clearly and completely describes the technical solutions in the embodiments of the present disclosure with reference to the accompanying drawings in the embodiments of the present disclosure. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

An objective of the present disclosure is to provide a micro-cathode arc propulsion system capable of improving the operating stability of a thruster as well as reducing additional power consumption of a circuit.

To make the objects, features and advantages of the present disclosure more apparent, the present disclosure will be described in further detail below with reference to the accompanying drawings and specific embodiments.

### Embodiment

FIG. 2 is a circuit diagram of a micro-cathode arc propulsion system 10 in accordance with an embodiment of the present disclosure. As shown in FIG. 2, the micro-cathode arc propulsion system 10 provided by the present disclosure comprises a power supply 11, a resistor 12, a capacitor 13, a permanent magnet 16, an IGBT module 14, and a micro-cathode arc thruster 15. A positive electrode of the power supply 11 is connected to one terminal of the resistor 12, the other terminal of the resistor 12 is connected to one terminal of the IGBT module 14 and one terminal of the capacitor 13, respectively, and the other terminal of the IGBT module 14 is connected to an anode of the micro-cathode arc thruster 15. A cathode of the micro-cathode arc thruster 15 and the other terminal of the capacitor 13 are connected to a negative electrode of the power supply 11, and the cathode of the micro-cathode arc thruster 15, the other terminal of the capacitor 13 and the negative electrode of the power supply 11 are all grounded. The IGBT module 14 comprises a pulse generator 401 and an IGBT 402. The pulse generator 401 is connected to a gate of the IGBT 402, a drain of the IGBT 402 is connected to the other terminal of the resistor 12, and a source of the IGBT 402 is connected to the anode of the micro-cathode arc thruster 15. An insulating layer 501 of the micro-cathode arc thruster 15 is arranged between the cathode and the anode of the micro-cathode arc thruster 15, the permanent magnet 16 is arranged on the cathode of the micro-cathode arc thruster 15, and the power supply 11 is a pulse power supply. In accordance with the present disclosure, the thruster is powered by using a discharging mode of the capacitor 13. When the IGBT 402 is switched off, the capacitor 13 is charged by the power supply 11; and after the charging is finished, the IGBT 402 is switched on, the capacitor 13 discharges electricity to apply hundreds of amplitude voltages to the cathode and the anode of the thruster, thereby breaking through two polar plates of the thruster to form arc therebetween. The permanent magnet 16 in accordance with the present disclosure may also employ a magnetic exciting coil, the permanent magnet 16 or the magnetic exciting coil is configured to provide a magnetic field.

During implementation of the present disclosure, a power processing unit (PPU) comprises a resistor 12, a capacitor 13, and an IGBT module 14. The voltage released by the PPU is directly applied between the two polar plates of the micro-cathode arc thruster 15, and the voltage value may affect the state of the arc and thus affect the propulsion performance of the thruster. The capacitance may determine the maximum electric quantity in single discharging of the PPU, and the increase of the capacitance is helpful for boosting an output voltage of the PPU within a certain range. The switching frequency of the IGBT 402 may determine whether the PPU can reach the maximum discharging state and the stable and continuous output of power by the PPU.

To achieve the purpose of the stable operation of the micro-cathode arc thruster 15, it should be guaranteed that the PPU can acquire enough electric energy. In a case that parameters for the power supply are fixed, it is necessary to design the capacitance value, the charging time and a circuit resistance value, and the charging time of the capacitor 13 may be calculated by means of an empirical formula:

τ=RC

Where C is a capacitance value, R is a current-limiting charging resistance; τ is a charging/discharging time constant.

In accordance with the present disclosure, the micro-cathode arc propulsion system 10 is powered by using 500 V, in order to reduce the power inputted into the thruster as much as possible, the PPU should operate in a high-voltage and low-current state; in order to control the current to reduce, the resistance is chosen to be 50 kΩ. When the capacitance is 0.5 μf, the charging time constant of the capacitor 13 is 0.025, and when the time is greater than 0.125 s, it may be considered that the capacitor 13 has been fully charged. The equivalent resistance at the breakdown moment of the micro-cathode arc thruster 15 is generally in the order of several ohms to tens of ohms, which is related to design parameters of the thruster. When the equivalent resistance is 10 ohms, the discharging time constant is 5×10⁻⁶ s, and it can be considered that discharging of the capacitor 13 has been completed at 25×10⁻⁶ s under an ideal condition. Because the charging time (0.125 s) is much greater than the discharging time (25×10⁻⁶ s), the IGBT 402 may operate at the maximum switching frequency of 8 Hz, and based on such parameters, the thruster may operate work stably and efficiently in a low-power state.

In accordance with the present disclosure, the PPU circuit is changed, a 500 V DC power supply is used to supply power, and a traditional discharging mode of an inductor is replaced with a discharging mode of a capacitor which is more stable in discharging, thereby stabilizing the operation of the thruster. Due to the charging/discharging characteristics of the capacitor, the input power supply operates in a pulse manner so as to reduce the average power inputted into the thruster. As the internal resistance of the capacitor is small during operation, the additional power consumption in the PPU circuit is reduced. The voltage with the same amplitude is used to discharge the micro-cathode arc thruster 15, such that the discharging repeatability is improved, and the service life of the thruster is prolonged. In accordance with the present disclosure, the problem of power consumption of the PPU circuit in the micro-cathode arc propulsion system 10 is solved. During the discharging of the capacitor, the input power supply does not input power into the PPU circuit, and the input power supply operates in a pulse manner so as to achieve the purpose of reducing the power inputted into the thruster.

Several examples are used for illustration of the principles and implementation methods of the present disclosure. The description of the embodiments is merely used to help illustrate the method and its core principles of the present disclosure. In addition, a person of ordinary skill in the art can make various modifications in terms of specific embodiments and scope of application in accordance with the teachings of the present disclosure. In conclusion, the content of this specification shall not be construed as a limitation to the present disclosure.

The above embodiments are provided solely for the purpose of describing the present disclosure and are not intended to limit the scope of the present disclosure. The scope of the present disclosure is defined by the appended claims. Various equivalents and modifications made without departing from the spirit and principles of the present disclosure are intended to be within the scope of the present disclosure.

What is claimed is:

1. A micro-cathode arc propulsion system, comprising:
a power supply, a resistor, a capacitor, an IGBT module and a micro-cathode arc thruster;
a positive electrode of the power supply is connected to one terminal of the resistor, the other terminal of the resistor is connected to one terminal of the IGBT module and one terminal of the capacitor, respectively, and the other terminal of the IGBT module is connected to an anode of the micro-cathode arc thruster; a cathode of the micro-cathode arc thruster and the other terminal of the capacitor are connected to a negative electrode of the power supply.

2. The micro-cathode arc propulsion system according to claim 1, wherein the IGBT module specifically comprises:
a pulse generator and an IGBT;
the pulse generator is connected to a gate of the IGBT, a drain of the IGBT is connected to the other terminal of the resistor, and a source of the IGBT is connected to the anode of the micro-cathode arc thruster.

3. The micro-cathode arc propulsion system according to claim 1, wherein the power supply is a 500 V DC power supply.

4. The micro-cathode arc propulsion system according to claim 1, wherein the resistor has a resistance of 50 kΩ.

5. The micro-cathode arc propulsion system according to claim 1, wherein the capacitor has a capacitance of 0.5 μf.

6. The micro-cathode arc propulsion system according to claim 1, wherein the power supply is a pulse power supply.

7. The micro-cathode arc propulsion system according to claim 1, wherein an insulating layer of the micro-cathode arc thruster is arranged between the cathode and the anode of the micro-cathode arc thruster.

8. The micro-cathode arc propulsion system according to claim 1, further comprises:
a permanent magnet; and
the permanent magnet is arranged on the cathode of the micro-cathode arc thruster.

9. The micro-cathode arc propulsion system according to claim 1, wherein the cathode of the micro-cathode arc thruster, the other terminal of the capacitor and the negative electrode of the power supply are all grounded.
